(19) United States
(12) Patent Application Publication
(10) Pub. No.: US 2007/0108897 A1
(43) Pub. Date: May 17, 2007

(54) Electroluminescent display having electric shock prevention

(76) Inventors: Krishna D. Jonnalagadda, Algonquin, IL (US); Marc K. Chason, Schaumburg, IL (US)

Correspondence Address: MOTOROLA, INC., 1303 EAST ALGONQUIN ROAD, IL01/3RD, SCHAUMBURG, IL, 60196, US

(21) Appl. No.: 11/273,929

(22) Filed: Nov. 15, 2005

(51) Int. Cl. H01J 1/62; H01J 63/04

(52) U.S. Cl. 313/506

(57) ABSTRACT

An electroluminescent display device contains an electroluminescent phosphor sandwiched between a pair of electrodes. An optically transmissive layer of an electrically conductive material is coated on a side of the device that is presented to a human observer to aid in the prevention of electric shock. The electrically conductive material layer is electrically connected to ground, such as the ground of an AC power supply for the device.

### FIELD

This invention relates generally to luminescent displays. More particularly, this invention relates to a shock preventative electroluminescent display device.

### BACKGROUND

Electroluminescent panels, lamps, and displays are light-emitting displays for use in many applications. In 1936, G. Destriau discovered that certain phosphors, such as copper or manganese doped zinc sulphide, glow when subjected to a high voltage field (typically 10,000V/cm). Electroluminescent (EL) panels are essentially a capacitor structure with an inorganic phosphor sandwiched between two electrodes. The resistance between the two electrodes is almost infinite and thus direct current (DC) will not pass through it. But when an alternating voltage is applied, the build-up of a charge on the two surfaces effectively produces an increasing field (called an electric field) and this causes the phosphors to emit light. The increase in voltage in one direction increases the field and this causes a current to flow. The voltage then decreases and rises in the opposite direction. This also causes a current to flow. The net result is that current flows into (commonly thought of as “through”) the electroluminescent panel and thus energy is delivered to the panel. This energy is converted to visible light by the inorganic phosphor, with little or no heat produced in the process. Application of an alternating current (AC) voltage across the electrodes generates a changing electric field within the phosphor particles, causing them to emit visible light. By making the two electrodes so thin that light is able to pass through and be emitted to the environment, an optically transmissive path is available, so that the emitted light is visible to an observer, human or animal. Typically, the AC used to power EL devices is between 60-180 volts with frequencies in the range of 50-1000 Hz, with even higher frequencies used in signage applications in order to increase brightness. Voltages and/or frequencies at the higher end of either of these ranges, as well as operation at elevated temperatures, reduces the lifetime of the devices.

One particular area in which electroluminescent panels can be useful is in lighted signs for advertising and the like. In some of these applications, the temperature swings back and forth between high and low extremes. Under such circumstances, the differential expansions of the materials can cause the panel to flex repeatedly, causing premature aging of the various layers. Repeated temperature cycling can eventually cause cracks in the materials and cause the electroluminescent device to fail prematurely. Unlike the well-known liquid crystal displays (LCD) that use low voltage DC, common in so many of today's electronic devices, EL devices require high voltage AC. This high voltage needs to be stringently controlled to insure that an inadvertent and unexpected electric shock is not delivered to the human observer, since the outermost electrode typically is the “hot” electrode, i.e., carries a high voltage. One prior art solution to this problem has been to coat the top electrode of the device with an insulating or passivation layer. Thus, only the passivation layer prevents the high-voltage electrode from exposure. However, any number of sources can cause gaps or cracks in the passivation layer. For example, the temperature cycling described above can cause the passivation layer to crack and/or peel. Similarly, any number of sharp objects in the environment can strike the passivation layer, causing gaps, cracks, or holes and exposing the high-voltage electrode, posing a danger of electrical shock. Even a small pinhole of crack in the insulating or passivating layer can transmit an unwanted electric shock due to the relatively high operating voltages as compared to LCDs.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention. The drawings are intentionally not drawn to scale in order to better illustrate the invention.

FIG. 1 is an exploded isometric view of an electroluminescent device in accordance with certain embodiments of the present invention.

FIG. 2 is a partial cross sectional view of an electroluminescent device in accordance with certain embodiments of the present invention.

FIG. 3 is a cut-away isometric view of an electroluminescent device in accordance with certain embodiments of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention. The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The term AC, as used herein, is defined as a voltage or current that is alternating.

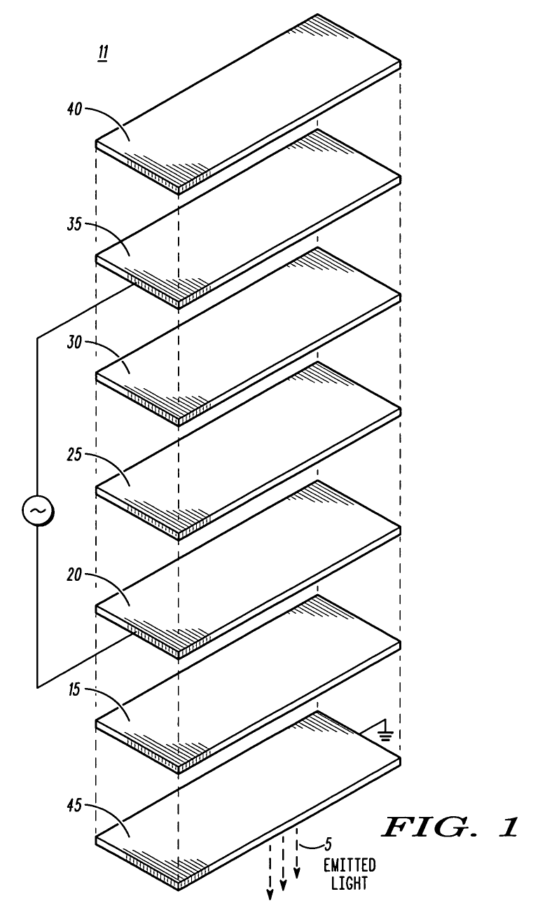

An electroluminescent display device contains an electroluminescent phosphor sandwiched between a pair of electrodes. An optically transmissive layer of an electrically conductive material is coated on a side of the device that is presented to a human observer to aid in the prevention of electric shock. This electrically conductive material layer is electrically connected to ground, such as the ground of an AC power supply for the device. Referring now to FIG. 1, one embodiment of our invention is formed by using screen printing techniques. The electroluminescent display device 11 emits light from a bottom side as depicted by arrows 5, and consists of a clear substrate 15, such as polyester film (for example, polyethylene terephthalate) that has disposed thereon a first electrode 20. The first electrode 20 can be a thin film of optically transmissive sputtered indium/tin oxide (ITO), or an optically transmissive conductive thick film ink. Disposed on the first electrode is a layer of electroluminescent phosphor 25. A layer of dielectric material 30 is sandwiched between the phosphor layer 25 and a second electrode 35. Another insulating layer 40 covers the second electrode 35. On the side of substrate 15 that is opposite to the side containing the first electrode 20 is disposed an electrically conductive layer 45 that is optically transmissive, i.e. translucent or transparent. This conductive layer 45 is connected to ground, for example the ground of an AC power supply used to deliver alternating voltage to the two electrodes. The electrically conductive layer 45 serves as a protective device to prevent electric shock to a human observer when the observer touches the surface of the device. If, for example, a crack or pinhole were to develop in the insulating substrate 15, then any stray voltage or current that might travel from the first electrode through the crack would be shunted to ground instead of to the observer. We have found that translucent conductive inks such as Luxprint 7162 and Luxprint 7164 from the DuPont Electronic Materials Company, USA, are suitable for fabricating the optically transmissive electrically conductive layer 45, although similar materials from other sources, such as inks containing indium/tin oxide, antimony/tin oxide or conductive polymers such as polyaniline, or other low loading solutions of other conductors such as carbon nanotubes, could be used with efficacy.

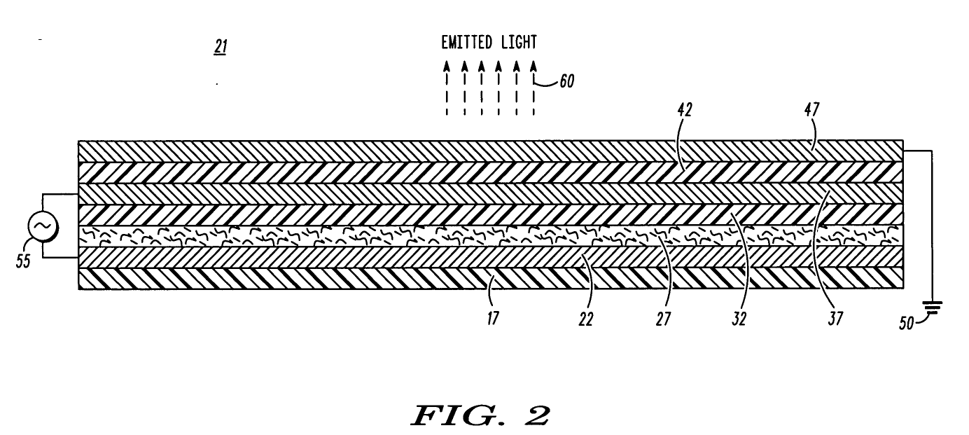

In an additional embodiment of our invention, depicted in FIG. 2, an electric shock preventative electrolumiscent device 21 consists of a substrate 17 that has a bottom electrode 22 situated thereon. In contrast to the embodiment depicted in FIG. 1, the substrate 17 and electrode 22 do not need to be optically transmissive, because the light is being emitted from the opposite side of the device, that is, not through the substrate and electrode. A layer of electroluminescent material 27 and a dielectric layer 32 are situated between the bottom electrode 22 and a top electrode 37. A source of alternating voltage 55 is coupled to the top and bottom electrodes to energize the electroluminescent material. An optically transmissive insulating or dielectric layer 42 is disposed over the top electrode, and an optically transmissive electrically conductive layer 47 is disposed on the insulating layer 42. This conductive layer 47 is connected to ground 50, for example, the ground of the AC power supply 55 used to deliver alternating voltage to the electrodes 22, 37. Since the electrically conductive layer 47 is situated on the side of the device 21 that is presented to the observer and on the side of the device from which visible light is being emitted, it serves as a protective device to prevent electric shock to the observer when the observer touches the surface of the device.

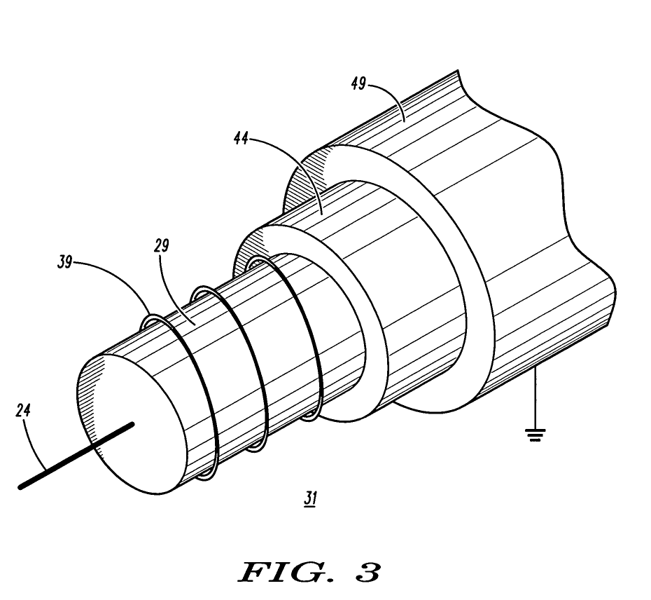

Having described two embodiments of our invention, it should be obvious that other arrangements of the various layers can be envisioned, yet still fall within the scope and intent of our invention. For example, the device does not necessarily need to be planar, it can assume other shapes, such as that of a co-axial cable. Referring now to FIG. 3, a shock preventative electroluminescent device 31 with several layers shown to exaggerated thickness for clarity of presentation, a cylinder of electroluminescent material 29 is disposed between a first conductor 24 and a second conductor 39. In this embodiment, the first conductor 24 is a wire situated axially in the center of the cylinder of EL material 29, and the second conductor 39 is disposed longitudinally about the outer circumference of the cylinder of EL material, similar to a ‘shield’in a conventional co-axial cable. Surrounding the second conductor 39 is a translucent dielectric layer 44, and surrounding that layer is an optically transmissive electrically conductive layer 49, that is connected to ground. Light is emitted radially from all exterior surfaces of the device 31, and all exterior surfaces provide electric shock prevention to an observer. An electroluminescent wire or cable 31 is constructed with a thick, stiff, inner wire 24 surrounded by a coating of light-emitting phosphors 29 and around this is wrapped a very fine outer wire 39. An outer clear plastic jacket or sheath 44 protects the chemicals and insulates the voltages on the wire from external leakage. A translucent electrical layer 49 surrounds the plastic jacket 44 and is connected to ground.

In summary, without intending to limit the scope of the invention, a shock preventative electroluminescent display device consistent with certain embodiments of the invention can be carried out by placing an optically transmissive layer of an electrically conductive material on a side of the device that is presented to a human observer to aid in the prevention of electric shock. This electrically conductive material layer is electrically connected to ground, such as the ground of an AC power supply for the device. Those skilled in the art will recognize that the present invention has been described in terms of exemplary embodiments based upon use of a conductive layer. However, the invention should not be so limited, since other variations will occur to those skilled in the art upon consideration of the teachings herein. For example, the optically transmissive electrically conductive layer does not need to be a single, continuous layer, it can be discontinuous; for example a series of discrete segments, such as stripes, or it can be in a mesh or grid pattern, so long as the individual members are connected to ground. Additionally, instead of using the AC power supply ground, other ‘grounds’can be connected to the optically transmissive electrically conductive layer, such as a package ground or a floating ground. The invention described herein can be suitably employed in, for example, point-of-sale consumer advertising signs at retail stores. The grounded outer transparent layer adds another measure of safety for the consumer.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims.

What is claimed is:

1. An electroluminescent display device comprising:
electroluminescent material disposed between a first conductor and a second conductor; and
an optically transmissive layer of electrically conductive material disposed on a side of the device presented to an observer, the layer of electrically conductive material electrically connected to ground.

2. The electroluminescent display device as described in claim 1, wherein the layer of electrically conductive material is transparent.

3. The electroluminescent display device as described in claim 1, wherein the layer of electrically conductive material is translucent.

4. The electroluminescent display device as described in claim 3, wherein the layer of electrically conductive material comprises an ink that can be printed by a contact or a non-contact printing process.

5. The electroluminescent display device as described in claim 1, wherein the layer of electrically conductive material comprises one or more materials selected from the group consisting of polymeric conductive inks, indium/tin oxide, and antimony/tin oxide.

6. The electroluminescent display device as described in claim 1, wherein the layer of electrically conductive material is discontinuous.

7. The electroluminescent display device as described in claim 1, wherein the ground is a ground of a power supply for the device.

8. The electroluminescent display device as described in claim 1, wherein the layer of electrically conductive material provides electric shock prevention for the human observer.

9. The electroluminescent display device as described in claim 1, wherein light is emitted through the optically transmissive layer of electrically conductive material toward a human observer.

10. The electroluminescent display device as described in claim 1, wherein the device comprises a coaxial cable.

11. An electroluminescent display device comprising:
an insulating substrate having a first electrode disposed thereon;
a layer of electrolumiscent material disposed on the first electrode;
a dielectric layer disposed on the layer of electrolumiscent material;
a second electrode disposed on the dielectric layer;
an insulating layer disposed on the second electrode; and
an electrically conductive layer disposed on the insulating layer, sufficient to allow an observer to see through the electrically conductive layer and view the electrolumiscent material when the device is energized, said layer of electrically conductive material electrically connected to ground of a power supply for the device.

12. The electroluminescent display device as described in claim 11, wherein the layer of electrically conductive material is optically transparent.

13. The electroluminescent display device as described in claim 11, wherein the layer of electrically conductive material is optically translucent.

14. The electroluminescent display device as described in claim 11, wherein the layer of electrically conductive material comprises an ink that can be printed by a contact or a non-contact printing process.

15. The electroluminescent display device as described in claim 11, wherein the layer of electrically conductive material comprises one or more materials selected from the group consisting of polymeric conductive inks, indium/tin oxide, and antimony/tin oxide.

16. The electroluminescent display device as described in claim 11, wherein the layer of electrically conductive material is discontinuous.

17. The electroluminescent display device as described in claim 11, wherein the ground is a ground of a power supply for the device, a package ground, or a floating ground.

18. The electroluminescent display device as described in claim 11, wherein the electrically conductive layer provides electric shock prevention for the observer.

19. An electric shock preventative electroluminescent panel comprising:
an insulating substrate having a first electrode thereon;
electroluminescent material disposed between the first electrode and a second electrode; and
an optically transmissive electrically conductive material disposed on a side of the electroluminescent panel presented for viewing by an observer, the layer of electrically conductive material electrically connected to ground of a power supply for the panel, to provide redundant protection to the observer from electric shock.

20. The electric shock preventative electroluminescent panel as described in claim 19, further comprising:
a dielectric layer situated between the electroluminescent material and the second electrode; and
an insulating layer, situated on a side of the second electrode opposite the electroluminescent material.
